(19) United States
(12) Patent Application Publication
(10) Pub. No.: US 2017/0199982 A1
(43) Pub. Date: Jul. 13, 2017

(54) AUTOMATED DISPENSER AND REGULATOR

(71) Applicant: Ergo Hum Safe Master, LLC, Charlestown, MA (US)

(72) Inventor: Mary-Porter Scott Brockway, Charlestown, MA (US)

(21) Appl. No.: 15/392,811

(22) Filed: Dec. 28, 2016

Related U.S. Application Data
(60) Provisional application No. 62/275,824, filed on Jan. 7, 2016.

(51) Int. Cl. G06F 19/00; A61J 7/04; B65H 35/00; A61J 7/00

(52) U.S. Cl. CPC G06F 19/3462; A61J 7/0076; A61J 7/0427; B65H 35/0086

(57) ABSTRACT

The present invention relates to automated devices, systems and methods for automatically controlling the dispensing of articles and for controlling access to dispensed articles, such as medication. In various aspects, an automated dispenser transfers articles from a storage compartment to an access compartment. A user has controlled access to dispensed articles in the access compartment. After a certain period of time, any untaken, dispensed articles in the access compartment can then be transferred to a holding compartment and are no longer accessible to the user. In certain aspects, an operator can access the compartments of the automated dispenser and program the automated dispenser to control the dispense and regulation of articles.

### RELATED APPLICATIONS

This application claims the benefit of priority of U.S. Provisional Application No. 62/275,824, entitled “Automated Pill Dispenser and Regulator” and filed Jan. 7, 2016, which is incorporated by reference in its entirety.

### FIELD

The present teachings generally relate to methods and devices for the dispensing of articles, and particularly, to methods and devices for providing automated dispensing and regulation of the dispensed articles.

### BACKGROUND

Known dispensing devices are utilized to dispense a variety of articles (e.g., medications, pet food, etc.). Medications, for example, are prescribed for a variety of reasons, including to treat a variety of health issues, and devices exist that are designed to help an individual properly administer their medications. To treat a particular health issue, a single medication or multiple medications can be administered. Administration includes a dosing schedule which is determined by the prescribing physician. The dosing schedule includes the amount and the frequency (e.g., the quantity at certain times) at which to take the medication. Often, individuals taking prescribed medications are responsible for administering their own medications. Individuals often receive a month's supply or more of medication with instructions on how to take the medication (e.g., dosage, timing, etc.). Traditional pill boxes, for example, thus help an individual organize their medications, usually for one week. Typically, these pill boxes are designed so pills can be loaded according to the days of the week.

An individual may have difficulty properly taking their medication for a number of reasons. For example, an individual may forget to take medication at the proper time, may have difficulty following the administration instructions, may be addicted to their medications, or have a combination of these issues. Additionally, an individual may be responsible for administering multiple medications, each with their own administration instructions. It is not unusual for a person to take more than one type of medication, each type in a different quantity, at different times each day.

Problems can arise when an individual does not comply with their prescription medications. Poor compliance may be detrimental to the individuals health. The efficacy of the medication may be reduced if the medication is not properly taken, or more serious effects may result if medication is not properly taken. There is also the possibility of the risk of overdose.

There remains a need for a device that can further aid in the dispensing of articles (e.g., an individual's medication) and prevent an individual from improperly administering such articles.

### SUMMARY

Described herein are devices and methods for controlling and regulating the dispensing of articles. Though particular reference is made herein to devices for dispensing and regulation of medications, it will be appreciated that such devices would have application not only in the administration of medication, but also in the administration of any articles that benefit, for example, from controlled administration. In accordance with various aspects of the present teachings, the devices and systems described herein include an automated dispenser that can provide a programmed release of articles (e.g., medication) from a storage compartment to an access compartment, from which the user can be provided access to the dispensed articles in the access compartment. After a certain period of time, any articles that remain in the access compartment (e.g., untaken medication) can then be automatically transferred to a holding compartment, where the dispensed article is no longer accessible to the user. An operator can access all or some of the compartments of the automated dispenser and can program the automated dispenser to control the release and regulation of the articles.

In accordance with various aspects of the present teachings, an automated dispenser is provided that comprises an enclosure defining a storage compartment, an access compartment, and a holding compartment, wherein the storage compartment is in communication with the access compartment. The holding compartment can also be configured to be in communication with the access compartment, wherein the communication between the holding compartment and the access compartment is controlled by a regulating mechanism. The automated dispenser can also comprise a dispensing mechanism configured to dispense one or more articles from the storage compartment into the access compartment. The automated dispenser can also comprise a locking mechanism configured to control access to the storage compartment, the access compartment, the holding compartment, or a combination thereof. In some aspects, the storage compartment and the access compartment can be in communication through one or more buffer compartments.

In various aspects, the automated dispenser can comprise an access port that provides access to the access compartment. In some aspects, the automated dispenser further comprises a control unit for controlling the regulating mechanism, the dispensing mechanism, the locking mechanism, or a combination thereof. In some aspects, the automated dispenser comprises a programming interface.

In various aspects, the automated dispenser dispenses one or more medications (e.g., a pill, tablet, a pill roll). The pill roll can comprise a plurality of packets, wherein each packet can comprise one or more medications. In some related aspects, the dispensing mechanism can comprise a rotatable spindle adapted to receive the pill roll. In such aspects, the dispensing mechanism can additionally include a separating mechanism configured to separate one of the plurality of packets from the pill roll. For example, the dispensing mechanism can comprise a mechanical arm.

In various aspects, the regulating mechanism comprises an operable hatch, a conveyor belt, a mechanical arm or a combination thereof.

In some aspects, the present teachings also provide a method of dispensing articles that benefit from controlled administration, such as medication, and can include using the systems and or devices described herein. In various aspects, the method of dispensing articles can comprise entering a first program into a programming interface, and entering a second program into the programming interface. The first program can control a dispensing mechanism in an automated dispenser, and the second program can control a regulating mechanism in the automated dispenser.

In various aspects, the method of dispensing articles comprises dispensing one or more articles from a storage compartment to an access compartment. In some aspects, the method can further comprise controlling access to the one or more articles at the end of a dosing period.

In some embodiments, the method of dispensing a medication comprises entering a third program. The third program can allow a user to override the first program, the second program, or a combination thereof.

In another aspect, the method of dispensing a medication further comprising activating a programming interface before entering the first program, the second program, the third program, or a combination thereof.

These and other features of applicant's teaching are set forth herein

### BRIEF DESCRIPTION OF THE DRAWINGS

Various features and advantages of the claimed subject matter will be apparent from the following description of the embodiments consistent therewith, which the description should be considered in conjunction with the accompanying drawings.

FIG. 1 illustrates a front view of an automated dispenser according to various aspects of the applicant's teachings.

FIG. 2A illustrates an exploded view of an exemplary automated dispenser according to various aspects of the present teachings.

FIG. 2B illustrates a front, cross-sectional view of the automated dispenser of FIG. 2.

FIG. 3A, in exploded view, illustrates another exemplary automated dispenser according to various aspects of the present teachings.

FIG. 3B illustrates a front, cross-sectional view of the automated dispenser of FIG. 3A.

FIG. 4A, in exploded view, illustrates another exemplary automated dispenser according to various aspects of the present teachings.

FIG. 4B illustrates a front, cross-sectional view of the automated dispenser of FIG. 4A.

FIG. 5 illustrates a front, cross-sectional view illustrates another exemplary automated dispenser according to various aspects of the present teachings.

FIG. 6A illustrates, in front view, another exemplary automated dispenser according to various aspects of the present teachings.

FIG. 6B illustrates a quartered, cross-sectional view of the automated dispenser of FIG. 6A, with the front rotated 45 degrees in a clockwise direction.

FIG. 6C illustrates a side, quartered, cross-sectional view of the automated dispenser of FIG. 6A.

FIG. 7A illustrates another exemplary automated dispenser according to various aspects of the present teachings.

FIG. 7B illustrates an exploded view of the automated dispenser of FIG. 7A.

### DETAILED DESCRIPTION

Those skilled in the art will understand that the methods, systems, and apparatus described herein are non-limiting exemplary embodiments and that the scope of the applicant's disclosure is defined solely by the claims. While the applicant's teachings are described in conjunction with various embodiments, it is not intended that the applicant's teachings be limited to such embodiments. On the contrary, the applicant's teachings encompass various alternatives, modifications, and equivalents, as will be appreciated by those of skill in the art. The features illustrated or described in connection with one exemplary embodiment may be combined with the features of other embodiments. Such modifications and variations are intended to be included within the scope of the applicant's disclosure. Accordingly, the following illustrative embodiments of the invention are set forth without any loss of generality to, and without imposing limitations upon, the claimed invention.

The present teachings generally relates to devices, systems and methods for automatically controlling the dispensing of articles and access to the dispensed articles. It will be appreciated that the present teachings can particularly be advantageous for the dispensing of articles that benefit from controlled administration (e.g., prescription medication, pet food, etc.). The devices, systems and methods described herein can, for example, control and regulate the programmed release of medication. For example, the devices allow for a programmed release of medication from a storage compartment to an access compartment. A user (e.g., person or animal requiring the dispensed medication) can access the dispensed medication in the access compartment. After a certain period of time, any untaken, dispensed medication in the access compartment can be transferred to a holding compartment, where it is no longer accessible to the user. An operator (e.g., the user, a physician, a pharmacist, etc.) can access all or some of the compartments of the automated dispenser (e.g., storage compartment, access compartment and holding compartment). An operator can also program the automated dispenser to control the release and regulation of articles.

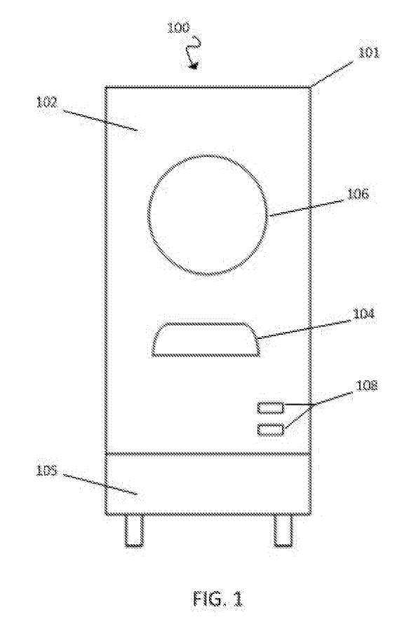

FIG. 1 illustrates a front view of an exemplary automated dispenser 100 according to various aspects of the present teachings that is configured to automatically dispense one or more articles contained within automated dispenser 100. For example, the automated dispenser 100 can automatically dispense (e.g., programmed release of) one or more medications. The programmed release of the medication can occur at any time interval and/or at any frequency. A medication can be dispensed, for example, once a day, twice a day, three times a day, four times a day, once a week, once a month, etc. The automated dispenser can also automatically dispense a first medication at a first time interval (e.g., once a day), a second medication at a second time interval (e.g., twice a day), a third medication at a third time interval (e.g., three times a day), etc. In some embodiments, 2, 3, 4, 5, 6, 7, 8, 9, 10 or more different types of articles can be dispensed at unique time intervals specific for that type of article.

Referring to FIG. 1, the automated dispenser 100 can include a housing 101 that encloses components of the automated dispenser 100. As shown, the automated dispenser can include a front cover 102 (i.e., the front of housing 101), which can include an access port 104, a display 106, and a programming interface 108. Access port 104, display 106, or programming interface 108 can be part of front cover 102. Base 105 can house the control unit, power source and other electronic components of automated dispenser 100.

Articles, such as medications, are stored within automated dispenser 100. The stored medications can be in any form (e.g., pills, capsules, gel-caps, pellets, tablets, other pharmaceutically acceptable preparations, or the like) and at any dosage. For example, common dosages for medications can vary, depending on the medicine and underlying health condition for taking that particular medication. Common dosages for medications taken orally (i.e., PO) usually range from about 1 milligram to about 1 gram. Medications can include prescription medications, non-prescription medications (e.g., over the counter medications), vitamins, supplements, and the like.

In various aspects of the present teachings, an operator can be responsible for loading the articles into automated dispenser 100 to be stored within automated dispenser 100. An operator can be any person or thing capable of loading the articles into the automated dispenser. When the articles are medication, a person capable of operating the device can include, for example, a pharmacist, doctor, or nurse. Other operators can be a machine, robot or other automated device. In some instances, the operator may be the user. One or more operators may be responsible for loading the articles into automated dispenser 100.

As described otherwise herein, automated dispenser 100 dispenses one or more medications. The programmed release of or dispensing of the one or more medications can occur according to a dispensing schedule. A dispensing schedule can set the times at which one or more articles are dispensed. For example, a dispensing schedule can set one or more medications to be dispensed at a certain time (e.g., 8 AM) every day of the week. In another example, a dispensing schedule can allow one or more medications to be dispensed twice a day (e.g., at 8 AM and 6 PM), every Monday, Wednesday, and Friday.

In certain aspects, articles stored within automated dispenser 100 can be generally inaccessible to a user until they are dispensed and therefore become accessible to a user. In some embodiments, the dispensed articles can be accessible to a user via access port 104. For example, access port 104 can provide a user access to the dispensed articles through front cover 102. Access port 104 can be an opening in front cover 102. Access port 104 can be covered by an operable door, hatch, or the like, that is operable to provide access to access port 104.

In various aspects, the dispensed articles can be accessible to the user for a predefined dosing period. As used herein, dosing period refers to a time period in which the dispensed article remains accessible. For example, a dosing period can be programmed based on a specific time period (e.g., 8:00 to 8:05 AM) or a length of time (e.g., 5 minutes). The dosing period can also be programmed so that the dosing period begins following a specific event, like the dispensing of one or more medications. At the end of the dosing period, any dispensed articles (e.g., medications) can then become inaccessible to a user.

In some embodiments, one or more (e.g., 1, 2, 3, 4, 5 or more) programs can be entered into automated dispenser 100 via programming interface 108. For example, a first program can be entered into automated dispenser 100 via programming interface 108 as a dispensing schedule. A dispensing schedule can provide instructions to the automated dispenser 100 regarding when to dispense articles. The dispensing schedule can allow and control the programmed release of one or more articles. In some aspects, a second program can be entered into automated dispenser 100 via programming interface 108 as a dosing period, for example, regarding the duration of a dosing period. In some embodiments, a third program can be entered into automated dispenser 100 as an override program. The override program can allow a user to override one or more of the first program and the second program, for example.

One or more operators can be responsible for entering one or more programs into automated dispenser 100 (e.g., programming the automated dispenser 100). For example, an operator can program a dispensing schedule and/or a dosing period in accordance with the teachings of the present invention. For example, an operator can program a dispensing schedule to configure automated dispenser 100 to dispense a medication at 8:00 AM on every Monday. An operator can also program a dosing period of, e.g., two hours. In such an example, the medication gets dispensed and becomes accessible at 8:00 AM on Monday, and could remain accessible via the access port 104 for the duration of the dosing period (i.e., two hours or until 10:00 AM). After the dosing period ends, the automated dispenser 100 can then make the medication inaccessible to a user. It will be apparent to one of ordinary skill in the art that the programming of the dispensing schedule and dosing period can be accomplished in a variety of ways to achieve the desired function. That is, the automated dispenser 100 can be programmed such that articles are dispensed at predefined or predetermined times and remain accessible to a user for a certain length of time.

Display 106 on front cover 102 can display information to a user. For example, display 106 can display information regarding automated dispenser 100, such as the programming of automated dispenser 100 including one or more dispensing period programs and/or one or more dosing period programs. Display 106 can be any type of visual display such as an LCD, LED, OLED, or similar display, all by way of non-limiting example.

As illustrated in FIG. 1 and noted above, the automated dispenser 100 can also include a base 105 that is part of housing 101 or can be separate therefrom. By way of non-limiting example, the base 105 can be configured to receive some or all of the electrical components necessary for the operation of the automated dispenser 100 as otherwise discussed herein. Examples of electrical components include, but are not limited to, a control unit and a power source. For example, base 105 may house the power source necessary to power the automated dispenser 100. A control unit can control the operations necessary to dispense the one or more medications. Nonetheless, it will be appreciated by the skilled artisan that any electrical component can be located in any other suitable location within or external to the automated dispenser 100 in accordance with various aspects of the present teachings.

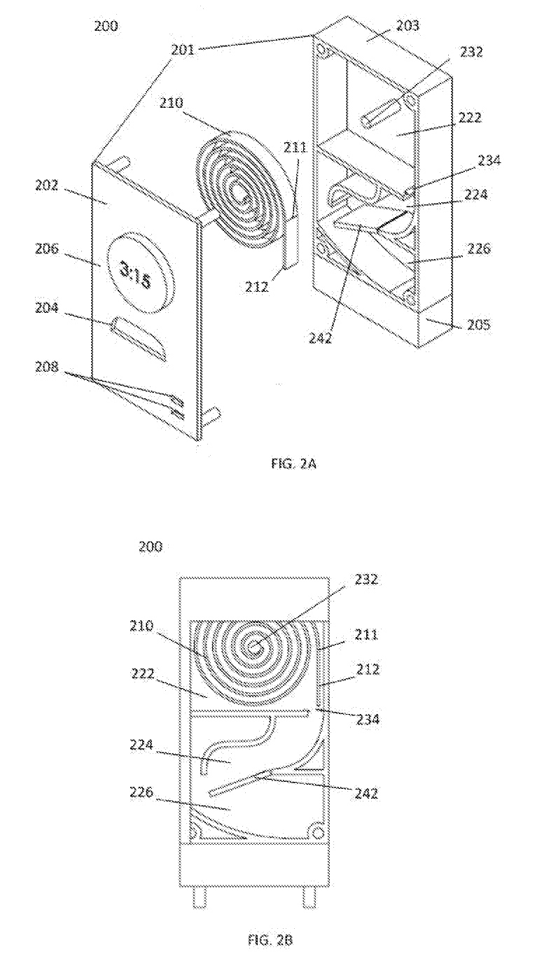

With reference now to FIG. 2A, an exploded view of an exemplary automated dispenser 200 according to various aspects of the present teachings is depicted. Automated dispenser 200 is configured to dispense one or more articles contained within automated dispenser 200. Front cover 202 and a back cover 203 of housing 201 fit together to enclose the internal components of the automated dispenser 200. A storage compartment 222, an access compartment 224, and a holding compartment 226 are each contained within the housing 201 of the automated dispenser 200. Front cover 202 and back cover 203 enclose storage compartment 222, access compartment 224, and holding compartment 226.

In various aspects, storage compartment 222 is configured to hold one or more articles, such as medications, which can be in the form of a pill roll 210, for example. Pill roll 210 can be a plurality of individual pill packets 212 that are joined and rolled to form a pill roll of packets. The joining of individual packets can be accomplished by various means known by one of ordinary skill in the art. For example, a frangible linkage 211 can be formed between the individual pill packets 212. Each individual pill packet 212 can contain one or more medications. The one or more medications can be in any form of suitable configurations for storage and dispensing.

FIG. 2B illustrates a front, cross-sectional view of automated dispenser 200. As illustrated in FIG. 2B, one or more medications in the form of a pill roll 210 can be loaded into the storage compartment 222, by for example, an operator. Access to the storage compartment 222 can be accomplished by various means. For example, storage compartment 222 can be accessible when front cover 202 is separated from back cover 203. The storage compartment 222 can be accessible through other means, such as a separate operable door configured to provide access to storage compartment 222.

A dispensing mechanism can be configured to dispense one or more of the articles contained within automated dispenser 200. A dispensing mechanism can be configured to dispense one or more articles according to a dispensing schedule. The dispensing mechanism can be any mechanism that causes the controlled release of one or more articles in the storage compartment to the access compartment. The dispensing mechanism can be a single component or a system of multiple components. The component or components of the dispensing mechanism are located in such a manner as to dispense the one or more articles. In some embodiments, the dispensing mechanism can be located outside the automated dispenser, inside the automated dispenser, or both.

In some embodiments, the dispensing mechanism can comprise a rotatable spindle 232 and cutting mechanism 234, as illustrated in FIGS. 2A and 2B. Rotatable spindle 232 is configured to receive pill roll 210 and can be configured to rotate, dispensing one or more pill packets. The rotatable spindle 232 can be configured to rotate in accordance with a dispensing schedule. The rotation of rotatable spindle 232 can aid in separation of a pill packet 212, from pill roll 210. For example, rotation of the spindle 232 can advance a pill packet 212 to allow a cutting mechanism 234 to cut pill packet 212 from pill roll 210. Cutting mechanism 234 can be any mechanism, device, or the like that separates at least one pill packet 212 from the pill roll 210. For example, cutting mechanism 234 may be a sharp edge (e.g., blade) that separates pill packet 212 from pill roll 210 by cutting frangible linkage 211.

It will be apparent to one of ordinary skill in the art in light of the present teachings, that a pill roll 210 can be manufactured in the order of which the medication is to be dispensed. In examples where only one medication is administered, the pill roll contains packets with only that medication. In other examples, a plurality of medications can be administered at a plurality of times such that the pill roll comprises packets containing medications to be administered in chronological order. In other examples, more than one pill roll may be loaded into storage compartment 222. Medication from each pill roll can be dispensed independently.

As best shown in FIG. 2B, access compartment 224 can be in communication with storage compartment 222 and can be configured to receive articles that are dispensed from storage compartment 222. For example, the dispensing mechanism can dispense pill packet 212 from the storage compartment 222 and into access compartment 224 (e.g., after it has been separated from pill roll 210 by cutting mechanism 234). Access compartment 224 can be in direct communication with storage compartment 222 or in indirect communication with the storage compartment 222 (e.g., via an intervening compartment or space located between the access compartment 224 and storage compartment 222).

In accordance with various aspects of the present teachings, articles received by access compartment 224 can remain within access compartment 224 until a user takes the articles from the access compartment. If a user does not take the articles from the access compartment, the articles (e.g., pill packet) can remain in the access compartment for the defined dosing period (e.g., 10 minutes, 30 minutes, 60 minutes, etc.), after which time the article can be automatically removed from the access compartment 224 such that it is no longer accessible to the user.

For example, front cover 202 can prevent access to the internal compartments of automated dispenser 200 including storage compartment 222, access compartment 224, and holding compartment 226, with the access port 204 providing a user access to articles (e.g., pill packet) contained within access compartment 224. For example, access port 204 can provide access through the front cover 202 into access compartment 224. For example, the access port 204 can be an opening in front cover 202 that can be configured and sized to allow for the removal of one or more articles in the access compartment 224 by a user.

In some embodiments, the access port 204 can be covered by a door, hatch, or the like, that is operable to provide access to access compartment 224. For example, access port 204 can be covered by an operable door built into front cover 202. The operable door can allow access to access compartment 224, via access port 204, through front cover 202, when the operable door is open. The operation of the operable door can be programmably controlled to allow access to the access compartment at designated times (e.g., when medication is released to the access compartment). The operable door can be configured and sized to allow the removal of one or more medications in the access compartment by a user, when the door is open. In some aspects, the operable door can prevent access to access compartment 224 when the door is closed. The operable door can be controlled to open according to a dispensing schedule and close at the end of a dosing period.

At the end of a dosing period, any untaken articles (e.g., medication that has not been removed from the access compartment 224) can become inaccessible to the user. For example, in accordance with various aspects the present teachings, the door covering the access port 204 can be actuated to close, thereby preventing a user access to the access compartment 224. Additionally or alternatively, any untaken articles can become inaccessible to the user by transferring some or all of the untaken, dispensed articles from access compartment 224 to a holding compartment 226.

In some embodiments, a regulating mechanism regulates the transfer of untaken, dispensed articles from an access compartment to a holding compartment. The regulating mechanism can be any mechanism that causes one or more articles to be transferred out of the access compartment. The regulating mechanism can be a single component or can be a system comprising multiple components. The component or components of the regulating mechanism are located in such a manner as to transfer the one or more articles out of the access compartment. For example, in some embodiments, the regulating mechanism can be located within the automated dispenser, outside of the automated dispenser or a combination thereof.

As illustrated in FIGS. 2A and 2B, the regulating mechanism can be an operable hatch 242, for example, that can be located at or near a boundary between access compartment 224 and holding compartment 226. The operable hatch 242 can provide communication between access compartment 224 and holding compartment 226. For example, after a dosing period has ended, operable hatch 242 can allow for the transfer of one or more articles from access compartment 224 to holding compartment 226. The transfer of one or more articles from access compartment 224 can be performed by opening operable hatch 242 causing articles (e.g., a pill packet 212) to fall or otherwise be released into holding compartment 226.

As described herein, holding compartment 226 can be in communication with access compartment 224. Holding compartment 226 is configured to receive untaken articles from the access compartment 224. At the end of a dosing period, any untaken article in access compartment 224 can be transferred out of the access compartment 224. The untaken article can be received and held by the holding compartment 226. Holding compartment 226 is configured to receive and hold any and all untaken articles.

In some embodiments, an operator can access the articles in holding compartment 226. Access to the holding compartment 226 can be accomplished by various means. For example, holding compartment 226 can be accessible when front cover 202 is separated from back cover 203. Holding compartment 226 can be accessible through other means such as, a separate operable door configured to provide access to holding compartment 226.

Access to the internal contents (e.g., the access compartment, the storage compartment, holding compartment, etc.) of automated dispenser 200 can be controlled by one or more locking mechanisms in accordance with various aspects of the present teachings. In some aspects, for example, a locking mechanism can prevent access to storage compartment 222 and holding compartment 226 by preventing the separation of front cover 202 from back cover 203. Additionally or alternatively, a locking mechanism can prevent access to access compartment 224 via access port 204 by preventing the operation of an operable door covering access port 204. In various aspects, a single locking mechanism can control and prevent access to any of the compartments of the devices described herein or each compartment can be controlled by a different locking mechanism.

It will be appreciated that the one or more locking mechanisms can be mechanical, electrical, magnetic or any other type of locking mechanism known in the art and modified in accordance with the present teachings. In some embodiments, the one or more locking mechanisms may be located within automated dispenser 200. In some embodiments, the one or more locking mechanisms can be located on housing 201 of automated dispenser 201. In some embodiments, an operator can control each of the one or more locking mechanisms. For example, the operator can control each of one or more locks. That is, the operator can cause each of the one or more locking mechanisms to lock or unlock. In some aspects, the operator can control all or some of the one or more locks simultaneously. For example, the operator can control all or some of the locking mechanisms mechanically, electronically, or any other form known in the art. The operator may control the one or more locking mechanisms via direct contact of the one or more locking mechanisms, a program entered into automated dispenser 200, or remotely (e.g., through a wireless connection).

A control unit can control the operations of automated dispenser 200, for example, the operations of the dispensing mechanism, the regulating mechanism, the locking mechanism, or a combination thereof. For example, in some embodiments, a control unit associated with the automated dispenser 200 can cause the dispensing mechanism to dispense one or more articles, the regulating mechanism to transfer one or more articles from the access compartment 224 to the holding compartment 226, and/or one more locking mechanisms to lock or unlock. In various aspects, the control unit can control the operations of automated dispenser 200 based on the programming of the automated dispenser 200. For example, a control unit can be capable of receiving, sending, storing, running programs, or a combination thereof. The control unit can be in communication with programming interface 208 from which the control unit can receive one or more programs (e.g., instructions) via programming interface 208. The control unit can also be capable of sending one or more programs via programming interface 208. In various aspects, the control unit can include memory devices to store programs and/or processors to run programs to control the operations of automated dispenser 200 in accordance with program instructions.

In some embodiments, an operator (e.g., a medical professional, etc.) can enter a program into the programming interface to be stored and run by the control unit. For example, an operator can enter a first program that controls the dispensing mechanism. The first program can contain instructions for when (e.g., every day at 9 AM) and how (e.g., rotating rotatable spindle 232) to operate the dispensing mechanism. In such aspects, the control unit can execute the first program to operate the dispensing mechanism and/or to cause automated dispenser 200 to dispense one or more articles according to the dispensing schedule. In some aspects, an operator can enter a second program that controls the regulating mechanism and which can contain instructions for when and how (e.g., opening operable hatch 242) to operate the regulating mechanism. Thus, the second program can set a dosing period and the control unit can run the second program to cause automated dispenser 200 to render one or more articles inaccessible to a user according to the dosing period.

A programming interface can be any interface an operator can use to enter a program. A programming interface can allow an operator to enter a program directly on the automated dispenser 200, through a wired connection, through a wireless connection, or a combination thereof. The programming interface can comprise tactile buttons, a touchscreen, an electronic port, a radio transceiver, and/or any other components known in the art. In one exemplary aspect, an operator can enter a program into programming interface 208 located on the automated dispenser 200. Programming interface 208 can be tactile buttons. The automated dispenser can contain programming options for entering a variety of programs. For example, automated dispenser can contain programming options for entering a program controlling the dispensing mechanism, the regulating mechanism, the locking mechanism, or a combination thereof. Display 206 can aid in programming by displaying the programming options to an operator. Using tactile buttons, the operator can select the appropriate programming options to enter a program.

In another example, the operator can enter a program through a wired connection. Programming interface 208 can be an electronic port, such as a Universal Serial Bus (USB) Port. An operator may establish a wired connection between a computer, or similar device, to the electronic port. Using a computer, or similar device, the operator can enter programming through the wired connection into the electronic port.

In another example, the operator can enter a program through a wireless connection. Programming interface 208 can be a radio transceiver configured to be compatible with a wireless protocol, such as Bluetooth or Wi-Fi. An operator can establish a connection to the programming interface using a device that is compatible with the same wireless protocol. For example, an operator can use a Bluetooth compatible computer or mobile phone to connect to the Bluetooth compatible programming interface. Through this wireless connection, the operator can enter a program into the programming interface 208.

In various aspects, programming interface 208 can be designed to only receive programming from an authorized operator. By way of example, the programming interface 208 can require authorization before a program can be entered. In various aspects, authorization can be in the form of a security code, biometric scanner, use of an authorized device, or any other form of providing authorization known in the art and modified in light of the present teachings. For example, an operator can be required to enter a code into program interface 208 before it allows the operator to enter a program. Authorization can be required after each program is entered, after a wireless or wired connection is broken, after a set amount of time, or after the operator sets the programming interface 208 to require authorization.

Programming interface 208 can be designed to accept limited authorization. Limited authorization can allow limited programs to be entered. For example, a dosing period can end before a user takes the dispensed article, such as medication, leaving the user without their medication. A user can be given limited authorization to enter a program that dispenses the needed medication. In some embodiments, a user in need of medication can receive a limited authorization code from an operator. The limited authorization code can allow the user to enter a program to override an existing program, controlling the dispensing of medication, to dispense their needed medication.

In some aspects, a user can use programming interface 208 with limited functionality. For example, a user without authorization to enter a program can use the programming interface with restricted functionality. For example, a user without authorization can operate and set display setting(s).

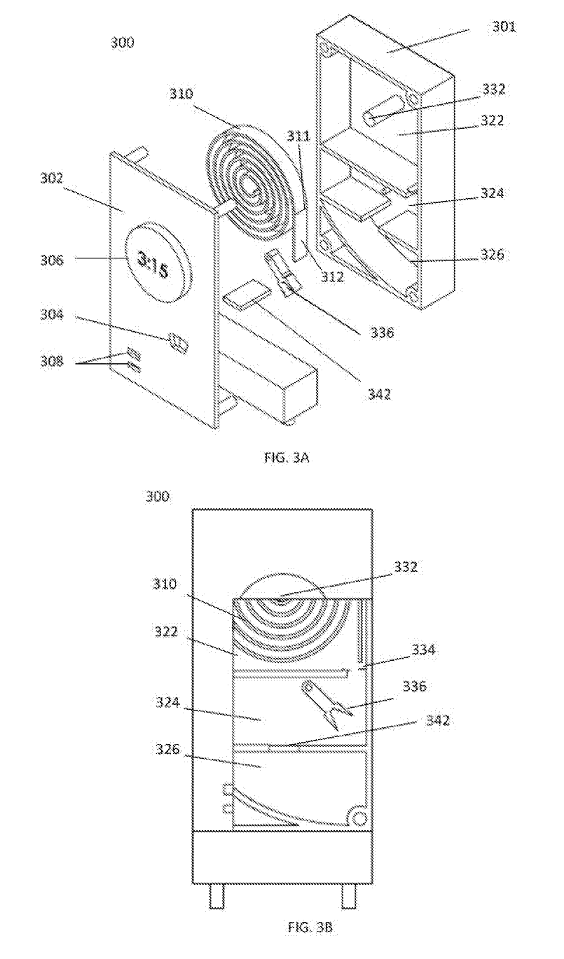

FIGS. 3A and 3B illustrate another exemplary automated dispenser 300 according to various aspects of the present teachings. FIG. 3A illustrates an exploded view of automated dispenser 300 and FIG. 3B illustrates a front, cross-sectional view of automated dispenser 300. As shown in FIGS. 3A and 3B, the dispensing mechanism includes rotatable spindle 332, a cutting mechanism 334, and a mechanical arm 336 that can assist in the transfer of articles from the storage compartment 322 to the access compartment 324. By way of non-limiting example, mechanical arm 336 can pull the one or more articles out of storage compartment 322 or catch the one or more articles as they exit the storage compartment 322. In some aspects, for example, mechanical arm 336 can release the packet 312 into the access compartment or can hold the one or more articles until the end of a dosing period. In some embodiments, mechanical arm 336 can implement or assist in the transfer of articles from a buffer compartment (not shown) to the access compartment 324.

In some embodiments, a mechanical arm 336 can be a component of the dispensing mechanism, regulating mechanism, or both. For example, mechanical arm 336 may be a component of the dispensing mechanism to dispense pill packet 312 from storage compartment 322 to access compartment 324 and then act as a component of the regulating mechanism to transfer pill packet 312 out of access compartment 324. The regulating mechanism can include mechanical arm 336 and operable hatch 342, alone or in combination. It will be apparent to one of ordinary skill in the art that various components of automated dispenser 300 can be designed and operated to perform multiple functions.

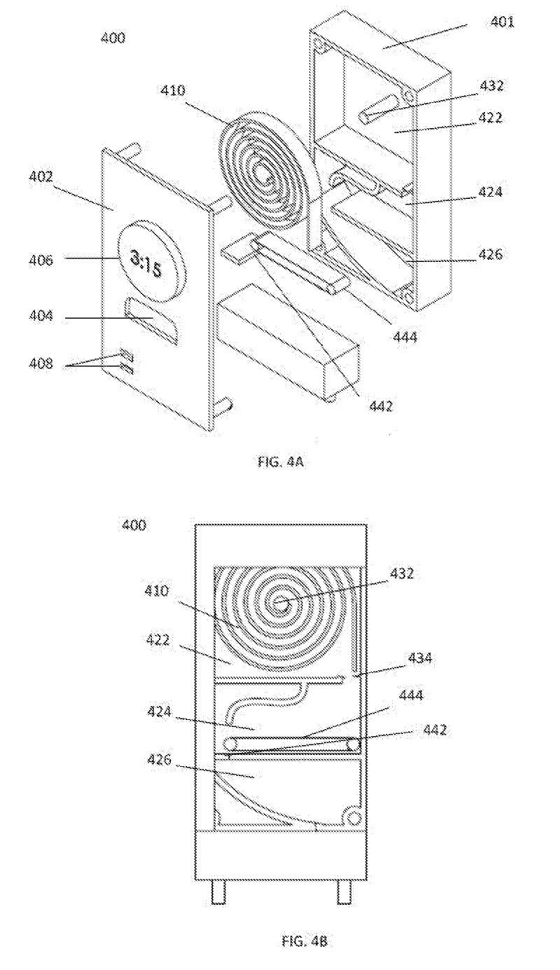

With reference now to FIGS. 4A and 4B, another exemplary automated dispenser 400 according to various aspects of the present teachings is depicted. FIG. 4A illustrates an exploded view of automated dispenser 400 and FIG. 4B illustrates a front, cross-sectional view of automated dispenser 400. As shown in FIGS. 4A and 4B, the regulating mechanism includes conveyor belt 444 and hatch 442. The conveyor belt 444 can be operable to transfer one or more untaken articles out of access compartment 424 and into the holding compartment 426. By way of example, the conveyor belt 444 can position the untaken articles onto operable hatch 442, which can be opened to transfer the articles into the holding compartment 426.

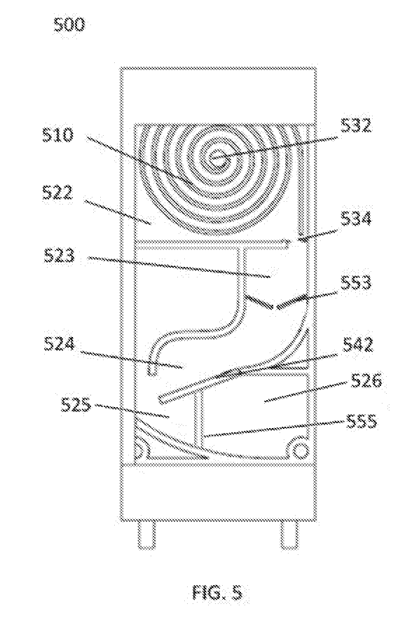

In some aspects, the dispensed articles may not pass directly from the storage compartment into the access compartment or directly from the access compartment into the holding compartment. For example, it may be desirable to include one or more buffer compartments to provide additional separation between the compartments. FIG. 5 illustrates a front, cross-sectional view of another exemplary automated dispenser 500 according to various aspects of the present teachings in which one or more buffer compartments are utilized to provide additional separation. As shown, automated dispenser 500 comprises storage compartment 522, access compartment 524, and holding compartment 526, with buffer compartment 523 being enclosed within automated dispenser 500 between the storage compartment 522 and access compartment 524 and buffer compartment 525 being enclosed within automated dispenser 500 between the access compartment 524 and the holding compartment 526. Thus, as illustrated in FIG. 5, storage compartment 522 and access compartment 524 are in communication with one another through buffer compartment 523, which can aid in preventing a user from accessing the storage compartment 522 through the access compartment 524. Articles dispensed from storage compartment 522 can first pass into buffer compartment 523. The buffer compartment can then transfer the dispensed articles into access compartment 524. Before the transfer of medication to the access compartment 524, an operable barrier can be set to block access to the storage compartment. In FIG. 5, the barrier 553 can be actuated (e.g., opened) to transfer the dispensed articles into the access compartment 524 and actuated (e.g., closed) to prevent access to buffer compartment 523 or the storage compartment 522. Additionally or alternatively, access compartment 524 and holding compartment 526 can be in communication with one another through buffer compartment 525, which can aid in preventing a user from accessing untaken articles from within the holding compartment 526 through the access compartment 524. Untaken articles removed from access compartment 524 can first pass into buffer compartment 525 and can then be transferred into holding compartment 526. After the transfer of medication to the holding compartment 526, an operable barrier 555 can be set to block access to the holding compartment 526. For example, the barrier 555 can be actuated (e.g., rotated to open, withdrawn, retracted) to transfer the untaken articles into the holding compartment 525 and actuated (e.g., rotated to close, extended) to prevent access to the holding compartment 526.

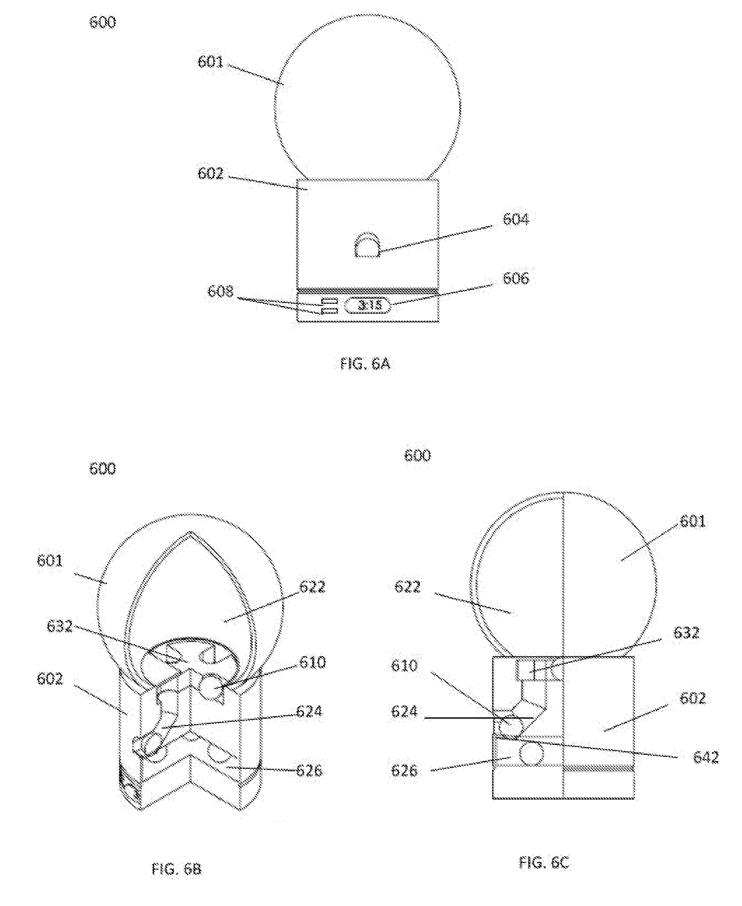

With reference now to FIGS. 6A-C, another exemplary automated dispenser 600 according to various aspects of the present teachings is depicted. FIG. 6A illustrates a front view of the automated dispenser 600 and FIG. 6B illustrates a quartered, cross-sectional view of automated dispenser 600, with the front rotated about 45 degrees in a clockwise direction. FIG. 6C illustrates a side, quartered, cross-sectional view of automated dispenser 600. As shown, automated dispenser 600 comprises a dome-shaped casing 601 and a body 602. The dome-shaped casing 601 can define the storage compartment 622 as discussed otherwise herein, while the body 602 can enclose access compartment 624 and holding compartment 626.

As best shown in FIG. 6B, storage compartment 622, which can be configured to hold one or more articles (e.g., medications) can be in communication with access compartment 624 so as to provide the article(s) thereto. A dispensing mechanism comprising a rotatable gear 632 can be disposed between the storage compartment 622 and access compartment 624, the dispensing mechanism containing a plurality of slots, each of which can be configured to hold a single article. By way of example, the slots can be configured in the shape of the article itself (e.g., a tablet) or a container 610 within which an article is enclosed (e.g., a spherical container containing a single medication or a plurality of medications to be taken together at a scheduled time) and can be configured to release the article to the access compartment when the rotatable gear 632 is aligned such that a slot is aligned with an opening to the access compartment 624. As discussed otherwise herein, the dispensed article can be accessible to a user through access port 604 in the body 602, and a regulating mechanism comprising hatch 642 can transfer any untaken medication into holding compartment 626.

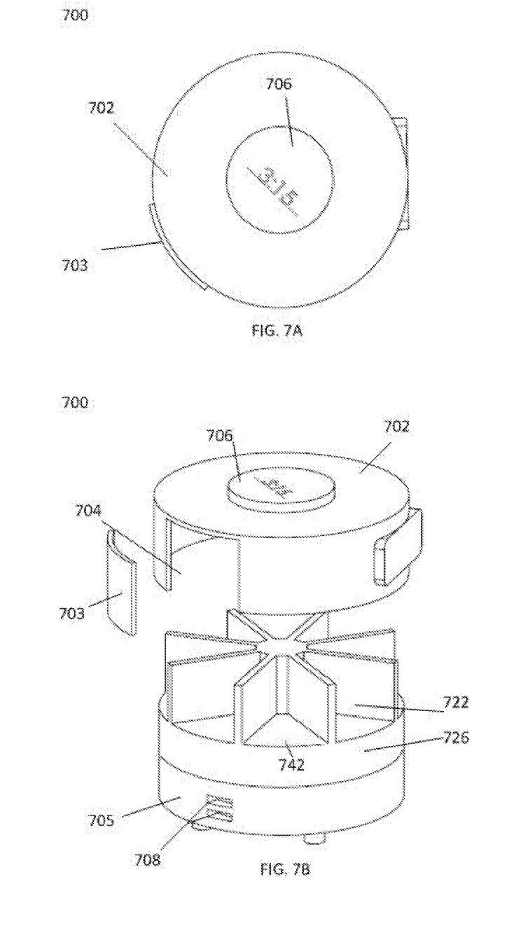

In various aspects, the storage compartment and the access compartment can comprise a compartment. With reference now to FIGS. 7A-B, another exemplary automated dispenser 700 in accordance with the present teachings is depicted in which the compartment 722 serves as both the storage compartment and an access compartment. As shown in FIGS. 7A-B, automated dispenser 700 includes a generally circular cover 702 that can attach to base 705 to enclose the internal components of automated dispenser 700. One or more locking mechanisms can control the attachment of cover 702 to base 705. Additionally, as otherwise discussed herein, a programming interface 708 can be located on the base and a display 706 can be located on top of the cover 702. It will be appreciated that the programming interface 708 and display 706 can be located in any convenient location on automated dispenser 700.

As shown, cover 702 can enclose one or more compartments 722, which can be formed by a plurality of walls extending out from a center spoke or axis. Any number of compartments can be formed and each can be sized to accommodate one or more articles. For example, 2 or more (e.g., 3, 4, 5, 6, 7, 8, 9, 10, 11, 12, 13, 14 or more) compartments can be disposed within dispenser 700, each of which can be configured to receive and store articles for dispensing according to a particular dispensing schedule. For example, one compartment can store medication that is to be dispensed in the morning and one compartment can store medication that is to be dispensed at night.

The one or more compartments 722 can be accessible through an access port 704, which can be covered by an operable door 703. A dispensing mechanism can be configured to rotate the compartments 722 around a central axis to align a single compartment 722 with the access port 704. Alternatively, the cover 702 and access port 704 can rotate to align with a single storage compartment 722. During a dosing period, a user can thus access the one or more articles in the compartment that is aligned with the access port 704.

Also, as discussed otherwise herein, the one or more compartments 722 can be in communication with holding compartment 726 such that after the dosing period has ended, a regulating mechanism can cause any untaken articles to be transferred from storage compartment 722 to holding compartment 726. The regulating mechanism can include operable hatch 742. At the end of a dosing period, operable hatch 742 can cause any untaken articles to be transferred from storage compartment 722 to holding compartment 726. Holding compartment 726 lies beneath the one or more compartments 722. In some aspects, for example, device 700 has a single hatch 742 for the transfer of articles to the holding compartment 726, while in other aspects, a hatch 742 is provided for each of the one or more compartments 722.

It will be understood by one of ordinary skill in the art that embodiments in addition to those described above can be utilized for the present invention. For example, it will be recognized that the orientation of the compartments of the automated dispenser to one another is inconsequential provided articles can be dispensed from a storage compartment to an access compartment and untaken articles can be transferred to a holding compartment. Each compartment can be separately enclosed and have the ability to, at times, be physically separated from the other compartments. Further, each mechanism can be placed in any manner to carry out its desired function. It will thus be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which alternatives, variations and improvements are also intended to be encompassed by the following claims.

What is claimed:

1. An automated dispenser, comprising:
a storage compartment configured to contain a plurality of medications to be dispensed;
a dispensing mechanism configured to transfer one or more medications from the storage compartment to an access compartment accessible by a user so as to provide access to the dispensed medication;
a regulating mechanism configured to control the transfer of one or more of the medications from the access compartment to a holding compartment when the dispensed medication within the access compartment is not accessed by the user within a dosing period; and
a locking mechanism configured to control access to the holding compartment.

2. The automated dispenser of claim 1, wherein the storage compartment and access compartment are in communication through one or more buffer compartments.

3. The automated dispenser of claim 1, wherein the access compartment and the holding compartment are in communication through one or more buffer compartments.

4. The automated dispenser of claim 1, further comprising an access port providing access to the access compartment.

5. The automated dispenser of claim 1, further comprising a control unit for controlling at least one of the regulating mechanism, the dispensing mechanism, and the locking mechanism.

6. The automated dispenser of claim 1, further comprising a programming interface.

7. The automated dispenser of claim 1, wherein the storage compartment is configured to contain a pill roll, wherein the pill roll comprises a plurality of packets of the medications to be dispensed.

8. The automated dispenser of claim 7, wherein the dispensing mechanism comprises a rotatable spindle adapted to receive the pill roll.

9. The automated dispenser of claim 7, further comprising a separating mechanism for separating one of the plurality of packets from the pill roll prior to transferring said packet to the access compartment.

10. The automated dispenser of claim 1, wherein the dispensing mechanism comprises a mechanical arm.

11. The automated dispenser of claim 1, wherein the regulating mechanism comprises at least one of an operable hatch, a conveyor belt, and a mechanical arm.

12. A method of dispensing medication from the automated dispenser of claim 1, the method comprising:
receiving a first program at a programming interface of the automated dispenser, wherein the first program controls the dispensing mechanism for transferring said one or more medications from the storage compartment to the access compartment; and
receiving a second program at the programming interface, wherein the second program controls the regulating mechanism so as to prevent access to the one or more articles at the end of the dosing period.

13. The method of claim 12, wherein the regulating mechanism is configured to transfer the one or more medications from the access compartment to the holding compartment.

14. The method of claim 12, further comprising receiving a third program at the programming interface, wherein the third program allows a user to override at least one of the first program and the second program.

15. The method of claim 12, wherein the storage compartment stores the medications to be dispensed.

16. The method of claim 15, wherein the storage compartment contains a pill roll comprising a plurality of packets of the medications to be dispensed.

17. The method of claim 16, wherein the dispensing mechanism comprises a rotatable spindle adapted to receive the pill roll.

18. The method of claim 12, wherein the dispensing mechanism comprises a mechanical arm.

19. The method of claim 18, wherein the mechanical arm is further configured to transfer the one or more articles from the access compartment into the holding compartment.

20. The method of claim 12, further comprising authorizing a user prior to activating the programming interface before entering at least one of the first program, the second program, the third program.
